(19) United States
(12) Patent Application Publication
(10) Pub. No.: US 2013/0056413 A1
(43) Pub. Date: Mar. 7, 2013

(54) MEMBRANE TREATMENT OF COOLING TOWER BLOW DOWN WATER

(71) Applicants: Hugh H. MIRANZADEH, Chicago, IL (US); John PEICHEL, Chaska, MN (US); Jason Michael KIZER, San Marcos, CA (US)

(72) Inventors: Hugh H. MIRANZADEH, Chicago, IL (US); John PEICHEL, Chaska, MN (US); Jason Michael KIZER, San Marcos, CA (US)

(73) Assignee: GENERAL ELECTRIC COMPANY, Schenectady, NY (US)

(21) Appl. No.: 13/223,865

(22) Filed: Sep. 1, 2011

(51) Int. Cl. C02F 1/44; B01D 65/02; B01D 71/38; B01D 71/34

(52) U.S. Cl. 210/636; 210/641; 210/650; 210/638

(57) ABSTRACT

Blow down water from an evaporative cooling system, such as a cooling tower, is treated for re-use as cooling make up water. Water in or entering the cooling system is treated with chemicals, for example corrosion inhibitors, scale inhibitors, or biocides. These chemicals are preferably chosen to be compatible with ultrafiltration (UF) and reverse osmosis (RO) membrane systems. Blow down water is removed from the cooling systems and filtered first through a UF membrane unit. The UF membrane unit removes total suspended solids (TSS), microorganisms and organic contaminants, among other things, from the blow down water. Permeate from the UF membrane unit is then filtered through a reverse osmosis (RO) membrane unit to remove, for example, divalent ions and hardness from the water. The RO membrane unit is preferably operated at a high cross flow velocity to reduce fouling. Permeate from the RO system is returned to the cooling system as make up water.

### FIELD

This specification relates to methods and apparatus for treating water, for example evaporative cooling blow down water, and to membrane filtration, for example ultra-filtration or reverse osmosis.

### BACKGROUND

The following description of background information is not an admission that anything described in this section is common knowledge or citable as prior art.

In an evaporative (also called open circuit) cooling system, water re-circulates around a device requiring cooling and through an evaporation area, such as a cooling tower. In the cooling tower, the hot water is exposed to the atmosphere. Some of the water evaporates, thus cooling the remaining water. The evaporated water is replaced with fresh make up water. Because the evaporation leaves solid and dissolved contaminants in the fresh water behind, the remaining water becomes concentrated with contaminants, including natural constituents of the fresh water such as calcium that become problematic when concentrated. Further, as the water is exposed to the atmosphere, it picks up contaminants from the atmosphere. Many of these contaminants have the potential to scale or foul elements, for example heat exchanger tubes, in the cooling system. Some of the contaminants are organic and support the growth of microorganisms, including pathogens such as Legionella that may be released from the cooling tower into the atmosphere. Accordingly, scaling, fouling and pathogen destruction are constant concerns when designing and operating cooling tower systems.

The problems of scaling, fouling and pathogen destruction may be addressed by various methods. For example, the fresh make up water added to replace evaporated water may be pre-treated to remove contaminants from it. This increases the amount of water that can be evaporated before the contaminants reach a concentration that causes scaling or fouling. Another general technique involves adding chemicals, for example anti-scalants, halogenating chemicals, or acids, to the re-circulating water. These chemicals increase the contaminant concentration that can be sustained without scaling or fouling, or inhibit the growth of microorganisms. Despite these techniques, however, the water would eventually reach a concentration of contaminants that will cause scaling or fouling if contaminants were not removed. Accordingly, a portion of the re-circulating water is withdrawn as a blow down stream, alternatively called a bleed stream. The flow rate of the blow down stream is determined by a mass balance required to keep the contaminant level at an acceptable level in view of the temperature and chemical composition (including additive concentrations) of the water in the cooling system.

Blow down water is typically sent to a sewer or otherwise wasted, possibly after some treatment to meet discharge permit requirements. However, various methods have been proposed to treat cooling tower blow down water to a re-use standard. Membrane systems have been used, generally speaking, to treat wastewaters but cooling tower blow down water is difficult to treat with membrane systems. One problem is that efficient operation of the cooling tower demands that the blow down water should have at least one contaminant at a concentration that is very close to causing fouling or scaling in the cooling system. Withdrawing filtered permeate through a membrane causes a further increase in the concentration of all retained contaminants, and may push one or more of those contaminants above a concentration that will foul the membranes. Another problem is that the chemicals used to delay scaling or fouling, or control pathogens, in a cooling tower may be harmful to the membranes. For these reasons, when membranes are used with cooling system blow down, they are typically placed after clarifiers or lime softening units, or combined with ion exchange units. Some re-use applications, such as lawn watering or toilet flush water, require only low quality water and membrane filtration is not required.

### INTRODUCTION TO THE INVENTION

The following introduction is intended to introduce the reader to the invention and the detailed description to follow, and not to limit any claimed invention to the elements or steps described in this introduction.

In a typical cooling tower application, a 100 gpm (this number is chosen to simplify calculations in this example) flow of municipal drinking water may be converted into 80 gpm of evaporated water and 20 gpm of blow down water. If reverse osmosis (RO) membranes are used to pre-treat the make up water, the cooling tower will be able to operate at a higher number of cycles of concentration. The cooling tower may then require only 82 gpm of pre-treated make up water, and discharge only 2 gpm of blow-down water, to provide the same 80 gpm of evaporated water. However, producing 82 gpm of RO permeate may require 95 gpm of municipal drinking water and produce 14 gpm of waste retentate, or brine. However, there is still a significant savings of 5 gpm in municipal drinking water, and a reduction of 4 gpm in water (blow down water and waste brine) discharged to a sewer.

While the use of an RO unit to treat the municipal drinking water provides a significant benefit, treating even 50% of the blow down water to about municipal drinking water standards would provide an even greater benefit. Considering the example above, without pre-treatment 100 gpm of water flows to the cooling tower and produces 20 gpm of blow down. The amount of blow down water discharged to a sewer is reduced to 10 gpm if half of the blowdown water is re-used as make up water. The re-use stream, also 10 gpm, reduces the amount of municipal drinking water consumed by a corresponding 10 gpm. Accordingly, the reductions in make up water and discharged water resulting from treating the blow down are greater than those achieved by treating the make up water. Further, since the blow down stream is only about one fifth of the size of the make up water stream, a membrane unit treating the blow down may be smaller and less expensive to operate, providing that fouling and membrane longevity issues can be overcome.

In some cases such as residential or commercial buildings, institutional uses such as schools and hospitals, or district energy systems, the amount of blow down is larger than any need for water other than make up water in at least one season. Accordingly, re-using the blow down water as cooling tower make up water might be the only way to make use of all of the blow down water. The cooling tower, however, requires high quality water, particularly when compared to some forms of water re-use such as irrigation or toilet flush water.

A process and apparatus are described herein for operating an evaporative cooling system such as a cooling tower. The cooling system blow down water is treated and re-used as cooling system make up water.

In a process, water in or entering a cooling system is treated with chemicals, for example corrosion inhibitors, scale inhibitors, or biocides. These chemicals are preferably chosen to be compatible with ultrafiltration (UF) and reverse osmosis (RO) membrane systems. Blow down water is removed from the cooling systems and filtered first through a UF membrane unit. The UF membrane unit removes total suspended solids (TSS), microrganisms and organic contaminants, among other things, from the blow down water. Permeate from the UF membrane unit is then filtered through a reverse osmosis (RO) membrane unit to remove, for example, chlorides, divalent ions and hardness from the water. The RO membrane unit is preferably operated at a high cross flow velocity to reduce fouling. Permeate from the RO system is returned to the cooling system as make up water. There are preferably no other major softening, de-ionizing, de-salting or demineralization unit process, such as lime softening, ion exchange, distillation or electrodialysis, used to treat the recycled make up water.

### BRIEF DESCRIPTION OF THE FIGURES

FIG. 1 is a schematic representation of a cooling system with a blow down water treatment system.

### DETAILED DESCRIPTION

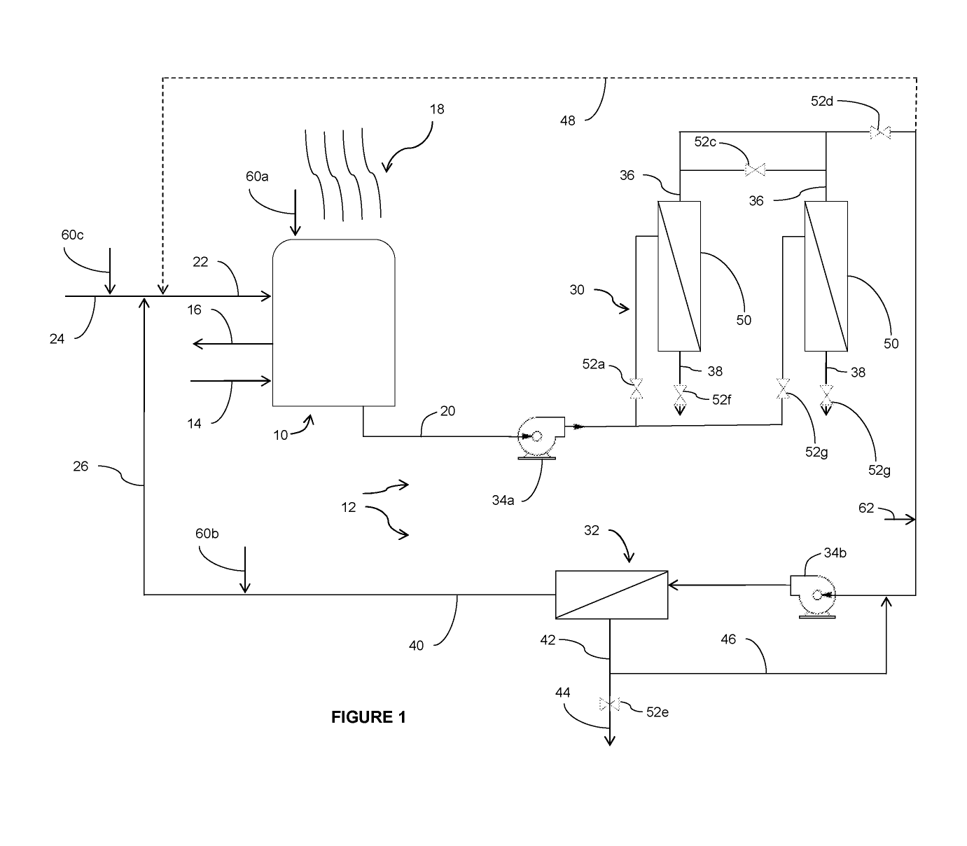

FIG. 1 shows an evaporative cooling system 10 coupled to a blow down treatment system 12 The cooling system 10 may be, for example, a cooling tower, evaporative condenser, evaporative cooler, or evaporation cooled air conditioner. The cooling system 10 receives hot water 14 from a device requiring cooling, such as an air chiller or a machine, and returns cooled water 16 to the device. The hot water 14 is exposed to the atmosphere in the cooling system 10, and a portion of the hot water 14 enter the atmosphere as evaporated steam, or vapor, 18. Another portion of the water flowing through the cooling system 10 is withdrawn as blow down, or bleed, 20. The loss of blowdown 20 and vapor 18 is replaced by make up water 22, which includes municipal water supply 24 and re-cycled blow down water 26. Blow down treatment system 12 receives the blow down 20 and produces the recycled blow down water 26. Preferably, 50% or more or 60% or more of the blow down 20 is recycled and returns to the cooling system 10.

The blow down 20 typically has a high mineral content, usually measured as total dissolved solids (TDS). TDS of the blow down 20 may be, for example, 500 to 1300 ppm. The blow down 20 may also contain microorganisms, such a bacteria or algae, some of which may be pathogens. The rate of blow down 20 removal may be controlled, for example, by a TDS or conductivity meter linked to a controller. The controller may be configured to release blow down 20 as required to maintain a pre-selected TDS concentration or conductivity in the water in the cooling system 10. Alternatively, blow down 20 may be released to produce a calculated number of cycles of concentration.

The blow down treatment system 12 has an ultrafiltration (UF) unit 30 and a reverse osmosis (RO) unit 32. The blow down 20 is fed by a pump 34a first to the UF unit 30. There are preferably no other major unit process, such as lime softening, settling or gravity clarification, ion exchange, media filtration, distillation or flotation, upstream of the UF unit 30. UF unit 30 produces a UF permeate 36 and, at least periodically, a UF retentate 38. UF permeate 36 is fed to the RO unit 32 by another pump 34b. RO unit 32 produces RO permeate 40 and RO retentate 42. Most, for example at least 70%, or all of the RO permeate 40 is sent to the cooling system 10 as recycled blow down water 26. Waste RO retentate 44 may be generated by withdrawing a bleed from RO retentate 42 recirculating through the RO unit 32, or during chemical cleaning or flushing procedures performed from time to time on the RO unit 32.

The UF unit 30 preferably has two or more membrane module 50. The membrane modules 50 are connected by valves 52 such that blow down 20 may flow through the modules 50 in parallel. However, when one of the membrane modules 50 needs to be backwashed, a feed valve 52a or 52b to the membrane module 50 to be backwashed is closed and a retentate valve 52f or 52g to that membrane module 50 is opened. A transfer valve 52c between the permeate side of at least one other membrane module 50 and the permeate side of the membrane module 50 to be backwashed is opened. A permeate valve 52d located between the permeate sides of the membrane modules 50 involved in the backwashing may be closed. In this way, permeate 36 from one membrane module 50 is forced in a reverse direction through another membrane module 50, causing that membrane modules 50 to be backwashed and to release UF retentate 38. Alternatively, UF permeate 36 may be stored in a tank and pumped in a reverse direction through a membrane module 50 to backwash the membrane module 50.

The UF retentate 38 and the waste RO retentate 44 act as a bleed of water from the cooling system 10. All of the contaminant in the RO permeate 40 are likely to reduced to such an extent that, even with repeated re-concentration in the cooling system 10, no contaminant accumulates in the cooling system 10. However, the release of UF retentate 38 and waste RO retentate 44 further guard against the possibility of any contaminant accumulating in the cooling system 10. In particular, the UF retentate 38 includes UF permeate 36 used in the backwashing procedure and the waste RO retentate 44 may include UF permeate 36 used to flush the RO unit 32 during cleaning procedures. The UF retentate 38 and the waste RO retentate 44 may be discharged, or sent for further treatment for example by way of an evaporator or crystallizer if near or zero liquid discharge (ZLD) is desired. Alternatively, the UF retentate 38 or waste RO retentate 44 may be used, optionally after further treatment, for less demanding re-use applications.

Each membrane module 50 has membranes with a nominal pore size of about 0.17 micron or less, preferably 0.05 microns or less, optionally to a lower limit of about 0.01 microns. The nominal pore size is the size of pores in the 95^{th} percentile of the pore size distribution of the membrane. The pore size distribution may be determined, for example, with software that analyzes scanning electron microscope (SEM) photographs of the membrane surface. In the upper end of the pore size range given above, and particularly under some membrane classifications schemes, the membrane module 50 may be considered to be a microfilter. The small pore size is preferred because the cooling tower blow down 20 tends to have significant concentrations of colloids and organic contaminants and these would tend to foul the membrane unit 32 if they were not substantially removed. The cooling tower blow down 20 is also likely to contain microorganisms which could cause bio-fouling in the RO unit 32 if they were not substantially removed. The membrane module 50 preferably provides at least 4-log removal of bacteria. The permeate 36 from the membrane module 50 preferably has total suspended solids (TSS) of 1 mg/L or less and a silt density index (SDI) of 5 or less, preferably 3 or less.

The membrane modules 50 preferably uses hollow fiber membranes, oriented vertically, with the separation layer on the outsides of the membranes. Flow through the membranes is from the outside of the membranes to their lumens. One, or preferably both, of the ends of the membranes are held in a potting head, typically a resin block. At least one end of each membrane is open to a permeate collecting cap over one of the potting heads. When the membranes are held inside of a pressure vessel, permeate is forced through the membranes by the pressure of feed water in the vessel. Permeate flows through the lumen of a membranes to an open end of a membrane, and is removed from the membrane module 50 through a port in the cap. In a large UF unit 30, the membranes may be contained in a tank at ambient pressure and UF permeate 36 is withdrawn with a suction pump attached to the cap. When the membranes are fitted inside of a pressure vessel, the pressure vessel preferably has a bottom drain for removing UF retentate 38, for example through holes in a lower potting head. Feed water may enter the membrane module 50 through an inlet port in the pressure vessel or tank, or through the drain. A separate inlet port near the top of a pressure vessel is preferred, however, to allow the vessel to be vented or flushed with feed water flowing from the inlet port to the drain. Suitable membrane modules 50 are sold by GE Water and Process Technologies under the ZeeWeed trade mark. For example, ZeeWeed 1500 pressurized modules may be used. The membranes in these modules are primarily PVDF with a nominal 0.02 micron pore size. The membranes may be cleaned with, for example, citric acid or NaOCl.

The cooling tower blow down 20 typically has a significant concentration of total suspended solids (TSS) in particle sizes ranging from 0.5 microns to 100 microns. These particles accumulate in the membrane modules 50 during periods of dead end filtration, for example as cake layer on the outsides of the membranes. The particles are removed by periodically backwashing the hollow fiber membranes with permeate, followed by draining the membrane module 50 as described above. A flush of feed water may be added to assist in removing the particles. The outside—in flow path, vertical configuration of the hollow fiber membranes, and bottom drain help provide a uniform flow to the membrane separation surfaces, and help remove the released cake layer after a backwash without accumulating solids in the feed side of the membrane module 50.

Most cooling tower blow down water 20 is halogenated. Seed microorganisms, and organic contaminants useful as food for the microorganisms, are brought into the cooling system 10 with the feed water 24, and when the hot water 14 is exposed to the atmosphere. Chemicals including chlorine or bromine may be added to the water in the cooling system 10 to reduce the growth of microorganisms. The membrane modules 50, and the RO unit 32 to a lesser extent, are preferably selected to be resistant to residual chlorine. For example, the membrane modules 50 may use membranes made primarily of PVDF.

Optionally, a portion 48 of the UF permeate 36 may return directly to the cooling system 10 without passing through the RO unit 32. In this case, the flow rate through the UF unit 30 is increased by the flow rate of this portion 48 in the direct return loop. The UF unit 30 in this case operates as a filter in a sidestream loop in addition to pre-treating blow down 20 for the RO unit. As a sidestream filter, the UF unit 30 is able to remove microorganisms, allowing the water in the cooling system 10 to be maintained at a lower concentration of halogens. In some cases, the need to destroy pathogens such as Legionella (which can infect people breathing mist from a cooling tower) forces cooling system operators to feed halogens to their cooling systems to the point of causing damage by corrosion. The UF unit 30, when used as a side stream filter, removes Legionella without increased halogenation. UF unit 30 also removes suspended solids, large organic contaminants, and other microorganisms to a greater extent than side stream multi-media or sand filters.

The RO unit 32 preferably uses spiral wound RO membrane elements that are resistant to fouling in difficult feed waters. Duraslick™ elements available from GE Water and Process Technologies, for example, use a 3 layer thin film composite membrane that has reduced surface roughness, due to a smooth middle layer, relative to standard 2 layer polyamide thin film composite membranes. The reduced surface roughness inhibits fouling in scaling and biofouling prone environments. These elements also have a chlorine tolerance of 500 ppm-hours. In addition to the three layer membrane, the Duraslick elements also uses a thick feed spacer, strong outer wrap, and robust plastic materials for the anti-telescoping devices and central tubes. Other low fouling membrane elements from other manufacturers use a PVA coating on the membrane surface to mask surface charges and to make the membrane surface smoother. Suitable membrane elements include, for example, Woongjin Chemical CSM RE-FE elements; AG HR Low Fouling elements; Dow FilmTec BW30FR elements; Koch Fluid Systems TFC FR elements; Nitto Denko Hydranautics LFC3-LD elements; PRO RO HR Low Fouling elements; and, Toray TML20 elements.

Multiple membrane elements may be used after being fitted end to end in tubular pressure vessels or housings. Within a housing, the feed water passes in series past the elements and becomes concentrated towards an outlet at one end of the housing. The housings may in turn be connected in series. Permeate from one housing may be connected to the feed inlet of another housing to provide multiple pass filtration. However, single pass RO filtration is sufficient to provide recycled water 26 of quality about equal to, or better, than the municipal supply water 24 and is preferred over multiple pass RO filtration.

A portion of the RO concentrate 42 travels through a recirculation loop 46 and is re-filtered. The extent of recirculation may be adjusted, for example by controlling valve 52c and the power of pump 34b. In experimental trials, recirculation rates giving a concentrate 42 flow rate to permeate 40 flow rate ratio of 2:1 and 3:1 (though with an upstream sand filter but without an upstream UF membrane unit 30) produced unacceptable fouling with and without adding acid upstream of the RO unit 32. Fouling was significantly reduced when the ratio was increased to 4:1 after installing a higher power pump 34b and an upstream UF membrane unit 30. A high cross flow velocity is generated with increased recirculation which helps reduces concentration polarization and increase turbulence. The increased turbulence reduces the fouling tendencies of organic contaminants.

In some applications, it might be acceptable to use a nanofiltration (NF) unit in place of the RO unit 32. In particular, if the contaminant salts in the blow down water 20 are primarily divalent, then an NF unit might provide acceptable rejection. However, since the intended use of the RO permeate 40 is for recycled make up water 26, which will then be concentrated in the cooling system 10 as much as possible, it is preferable to provide salt rejection to at or below the concentration of the municipal supply water 24. This makes the RO unit 32 preferable over an NF unit even in applications in which an NF unit may be acceptable.

Cooling tower chemicals 60a are added to the water in the cooling system 10 to inhibit bacterial growth, corrosion and scaling. The cooling tower chemicals 60a can be added using a dosing system programmed to monitor the concentration of contaminants in the water in the cooling system 10, determine the tendency of the contaminants to cause scaling (for example by calculating a Langelier Scaling Index), determine the existing concentration of cooling tower chemicals 60a, and then determine an additional amount of cooling tower chemicals 60a that needs to be added. Cooling tower chemicals 60b can also be added to the RO permeate 40 or at 60c to the municipal feed water 24 such that incoming water does not significantly dilute the water already in the cooling system 10.

The cooling tower chemicals 60 are chosen to be compatible with the UF membrane unit 30 and RO unit 32, and preferably to maintain a lower pH in the blow down water 20. For example, anionic polymers may be used to control calcium phosphate deposits. Most anionic polymers tend to foul UF membranes, but this fouling may be removed by periodic chemical cleaning of the UF membranes with an oxidant, provided that the membranes can tolerate oxidant cleaning. However, an acrylate copolymer may complex with inorganic contaminants in some cases and become difficult to remove. A terpolymer of acrylic acid may be used in concentrations up to 20 ppm in the blow down 20, is less likely to complex with inorganics, and so is preferred over an acrylate copolymer.

Calcium carbonate deposits may also be controlled by polymeric dispersants. Anionic polymers, such as polyacrylic acid (PAA), may be used but anionic oligomers such as polymaleic acid (PMA), used in concentrations up to 20 ppm in the blow down 20, are more effective in relation to their fouling potential. Phosphonates may also be used to control calcium carbonate deposits, and do not cause fouling in RO and UF membranes. Phosphonates may be used in concentrations up to 10 ppm in the blow down water 20. The phosphonates are preferred over anionic polymers and anionic oligomers for calcium carbonate deposit control, and also control corrosion in mild steel.

Phosphates and polyphosphates may also be used to control mild steel corrosion. Azoles, such as tolyltriazole (TTA) or a halogenated azole, may be used to control copper corrosion.

Biological contaminants in a cooling system 10 may be controlled with surfactants, oxidizers or nonoxidizers. Many surfactants, however, cause fouling and flux decline in membrane systems and so are not preferred. Oxidizers, such as chlorine and bromine, in theory oxidize RO membranes. However, in tests filtering blow down water 20 with an upstream UF membrane unit 30, no halogen degredation was detected in an RO membrane after 6 months of operation. It is possible that free halogens are consumed by organics in the cake layer of the UF membrane units 32. Biocidal nonoxidizers vary in their effects on membranes. DGH (dodecylguanidine hydrochloride) for example may cause fouling and flux decline in membrane systems while 2,2-dibromo-3-nitrilopropionamide (DBNPA), 2-bromo-2-nitropropane-1,3-diol (Bronopol), and isothiazolinones (such as Kathon™ sold by Dow) are compatible with membrane systems.

One or more conditioning chemicals 62 may optionally be added to the UF permeate 36 before it is fed to the RO unit 32, or to the cooling tower blow down 20 before it enters the UF unit 30. The retentate 42 recirculating through the RO unit 32 in particular will have approximately twice the concentration of contaminants in the blow down water 20. The conditioning chemicals 62 may include acids to lower the pH of the retentate 42 to inhibit scaling. Anti-scalant chemicals may also be added to reduce the tendency of the rententate 42 to cause scaling the feed side of the RO unit 32. In tests, however, the use of an anti-scalant (MDC 700) at 5 ppm in the UF permeate 36 did not extend the period of operation between clean in place (CIP) processes for an RO unit 32. It is possible that the concentration of contaminants in the retentate 42 exceeds the ability of at least moderate dosages of an anti-scalant to inhibit scaling. Other conditioning chemicals 62 might include sodium bisulfite to remove any remaining free halogens, or a reducing agent.

In a pilot study, the cooling tower in a high rise building was analyzed. The building uses 10 MM gallons of water to supply its cooling towers, which run at 4 cycles of concentration and discharge 2.5 MM gallons in blow down to a sewer. At a cost of $3/KGAL for the make up water, and $3/KGAL for discharge to the sewer, the cooling water costs are $37,500 per year. Recovering 60% of the blow down water and re-using it as make up water would reduce the make up water required by 1.5 MM gallons and reduce the discharge to the sewer by 1.5 MM gallons. This would result in a 25% reduction in water use and sewer discharge, and a savings of about $9,000 per year.

Based on particle counter readings, the blow down water had about 99,000 particles per mL in the size range of 0.5 to 200 microns. The particles were about 4 ppm by volume, with most of the volume of particles being in the range of 4 to 40 microns. An existing sand filter was retained for pre-filtering the blow down water. The sand filtered water had about 79,000 particles per mL, still with about a 4 ppm by volume. In contrast, UF filtration using a ZeeWeed™ 1500 membrane module resulted in permeate having about 24,000 particles per mL. These particles, however, were biased relative to the blow down water towards smaller particle sizes with the larger particles being removed almost completely. The volume of particles in the UF permeate was drastically reduced to about 0.02 ppm by volume. Subsequent filtration through an RO membrane further reduced the particle count to about 4,000 particles per mL, and reduced the particle volume to about 0.008 ppm.

Chemicals used in the cooling tower included an anionic polymer, an anionic oligomer, NaOCl, sodium bromide and sodium hypochlorite.

The goal of the system was to have the membrane modules last for at least a 6 month cooling season without replacement. A first round of tests were conducted using AK and AG membranes from GE Water and Process Technologies. These tests were conducted without UF pretreatment, but with and without sulfuric acid pre-treatment. An anti-scalant was added to the water fed to the RO membrane. Concentrate flow rate to permeate flow rate ratios were 2:1 and 3:1. These systems all fouled rapidly and could not sustain acceptable fluxes for the 6 month period.

In a second round of testing, the RO membranes were replaced with a Duraslick element operated at a concentrate flow rate to permeate flow rate ratio of 4:1. A ZeeWeed 1500 UF membrane unit was added upstream of the RO membranes. No acid or anti-scalant was added to the water fed to the RO membranes. This system operated for 6 months before being shut down voluntarily. The system was producing a satisfactory flux when shut down. An autopsy of the membrane element indicated that there was no material degredation of the membrane.

We claim:

1. A process for operating an evaporative cooling system comprising the steps of,
a) removing water from the cooling system;
b) filtering the water through a microfiltration or ultrafiltration membrane unit to produce a first permeate;
c) filtering at least some of the first permeate through a reverse osmosis membrane unit to produce a second permeate; and,
d) returning at least some of the second permeate to the cooling system.

2. The process of claim 1 wherein step c) comprises a step of operating a reverse osmosis membrane unit at a concentrate flow rate to permeate flow rate ratio of 4:1 or more.

3. The process of claim 1 wherein the water is not softened before step b).

4. The process of claim 1 wherein the there is no other softening, de-ionizing, de-salting or demineralization unit process used to treat the recycled make up water.

5. The process of claim 1 wherein a portion of the first permeate is returned to the cooling system without being filtered through the reverse osmosis membrane unit.

6. The process of claim 1 wherein water in or entering the cooling system is treated with chemicals chosen to be compatible with microfiltration or ultrafiltration and reverse osmosis membrane systems.

7. The process of claim 1 wherein the second permeate is produced by single pass reverse osmosis.

8. The process of claim 1 wherein the microfiltration or ultrafiltration membrane unit comprises membranes with a nominal pore size of 0.17 microns or less.

9. The process of claim 8 wherein the membranes are hollow fiber membranes with a separation layer on their outer surface and the membranes are oriented vertically in a pressure vessel with a bottom drain.

10. The process of claim 1 comprising steps of, adding an anionic polymer or oligomer to water in the cooling system; and, cleaning the microfiltration or ultrafiltration membrane unit with an oxidizer.

11. The process of claim 10 wherein membranes in the microfiltration or ultrafiltration membrane unit are made primarily of polyvinylidene fluoride.

12. The process of claim 1 comprising a step of adding a phosphonate to water in the cooling system.

13. The process of claim 1 comprising a step of adding an azole to water in the cooling system.

14. The process of claim 1 comprising a step of adding 2,2-dibromo-3-nitrilopropionamide, an isothiazolinone, or 2-bromo-2-nitropropane-1,3-diol to water in the cooling system.

15. The process of claim 1 comprising a step of backwashing the microfiltration or ultrafiltration membrane unit with first permeate and draining the membrane unit of retentate and backwash water.

16. The process of claim 15 wherein there are multiple microfiltration or ultrafiltration membrane units, and the first permeate used to backwash one membrane unit is drawn from another membrane unit.

17. The process of claim 1 wherein the reverse osmosis membrane unit comprises membranes with 3 layers or a PVA coating.

18. The process of claim 1 wherein 50% or more of the water is returned as second permeate to the cooling system.

19. The process of claim 1 wherein the first permeate is fed to the reverse osmosis membrane unit without adding a surfactant.

20. The process of claim 1 further comprising a step of adding make up water to the cooling system from a municipal water supply, wherein the second permeate has a lower TDS concentration than the make up water.
